(19) United States
(12) Patent Application Publication
(10) Pub. No.: US 2025/0135795 A1
(43) Pub. Date: May 1, 2025

(54) IMAGE PROCESSING APPARATUS, CONTROL METHOD THEREFOR, AND STORAGE MEDIUM

(71) Applicant: CANON KABUSHIKI KAISHA, Tokyo (JP)

(72) Inventor: NAO SAITO, Kanagawa (JP)

(21) Appl. No.: 18/914,572

(22) Filed: Oct. 14, 2024

(30) Foreign Application Priority Data
Oct. 25, 2023 (JP) 2023-183563

(51) Int. Cl. B41J 29/393; B41J 2/165; H04N 1/00

(52) U.S. Cl. CPC B41J 29/393; B41J 2/16517; H04N 1/00344

(57) ABSTRACT

An image processing apparatus counts, based on an execution of an operation that uses a consumable, consumable consumption information indicating the amount of the consumable used in the execution of the operation in association with an operation mode set in the execution of the operation. In a case where the executed operation is an operation related to a maintenance operation, the consumable consumption information indicating the amount of the consumable used in the execution of the operation is stored in a suspension history and counted in association with an operation mode set in an execution of a next printing operation unrelated to the maintenance operation.

### BACKGROUND

### Field

The present disclosure relates to an image processing apparatus, a control method therefor, and a storage medium.

### Description of the Related Art

Some users contract with service providers to use image processing apparatuses. Under these contracts, for example, the user pays their service provider a predetermined amount of money corresponding to the number of sheets printed per month. On the assumption of this use, there is a system including an image processing apparatus and a server apparatus with a counter function that counts the number of user operations charged and a calculator function that calculates a billing amount. Some image processing apparatuses, for example, operate in two different operation modes for different use applications, such as for work and private use. In this case, a company or employer for the user covers the cost of printing in the work operation mode, while the user covers the cost of printing in the private operation mode. In some cases, consumables for an image processing apparatus are used in maintenance operation different from the normal printing.

Japanese Patent Application Laid-Open No. 2022-46065 discusses a technique for calculating the amount of money charged as a maintenance cost based on the amount of printing for work.

In the conventional technique, it is unclear whether the maintenance operation from a user instruction other than the normal printing operation costs the company the amount for business use or the user for private use, regardless of the amount of printing. A simple determination who covers the cost based on an operation mode in the execution of a maintenance operation can result in an incorrect invoice recipient. For example, the normal printing in a private operation mode switched immediately after a maintenance operation in a work operation mode is done, and vice versa, can cost a company the amount for a maintenance operation for printing for private use or the user for a maintenance operation for printing for work. The technique does not take such an issue into consideration.

### SUMMARY

The present disclosure is directed to providing a technique for appropriately determining who covers the cost of consumables used in a maintenance operation based on the use application.

According to an aspect of the present disclosure, an image processing apparatus usable in a plurality of operation modes switched for different use applications, and is configured to count consumable consumption information indicating information about an amount of a consumable used for each of the operation modes, the image processing apparatus includes at least one memory storing at least one program and at least one processor, that when executes the at least one program causes the image processing apparatus to, count, based on an execution of an operation that uses the consumable, the consumable consumption information indicating the amount of the consumable used in the execution of the operation in association with an operation mode set in the execution of the operation, wherein in a case where the executed operation is an operation related to a maintenance operation, the consumable consumption information indicating the amount of the consumable used in the execution of the operation is counted in association with the operation mode set in an execution of a next printing operation unrelated to the maintenance operation.

Further features of the present disclosure will become apparent from the following description of exemplary embodiments with reference to the attached drawings.

### BRIEF DESCRIPTION OF THE DRAWINGS

FIG. 1A is an external view of an image processing apparatus according to an exemplary embodiment of the present disclosure. FIG. 1B illustrates the configuration of a printing unit of the image processing apparatus.

FIG. 2 is a block diagram illustrating a hardware configuration of the image processing apparatus according to the exemplary embodiment.

FIG. 3 is a block diagram illustrating a software configuration of the image processing apparatus according to the exemplary embodiment.

FIG. 4 is a conceptual diagram illustrating a relationship between the image processing apparatus according to the exemplary embodiment and a contract server.

FIG. 5 illustrates an example of a use history information screen of the image processing apparatus according to the exemplary embodiment.

FIG. 6 is a flowchart illustrating a processing of determining a recording destination for consumables count information according to the exemplary embodiment.

### DESCRIPTION OF THE EMBODIMENTS

Exemplary embodiments of the present disclosure will now be described in detail with reference to the accompanying drawings. The following exemplary embodiments are not intended to limit the scope of the attached claims, and not all combinations of features described in the exemplary embodiments are used to implement the exemplary embodiments.

### Outline of Contract for Use

A user can use a certain service under a subscription contract to an image processing apparatus according to an exemplary embodiment of the present disclosure. The contents of a subscription contract are not particularly limited. In the present exemplary embodiment, a subscription contract is one where a user pays a fixed fee every month to be permitted to use functions of the image processing apparatus up to a predetermined number of sheets and have ink for the image processing apparatus automatically delivered.

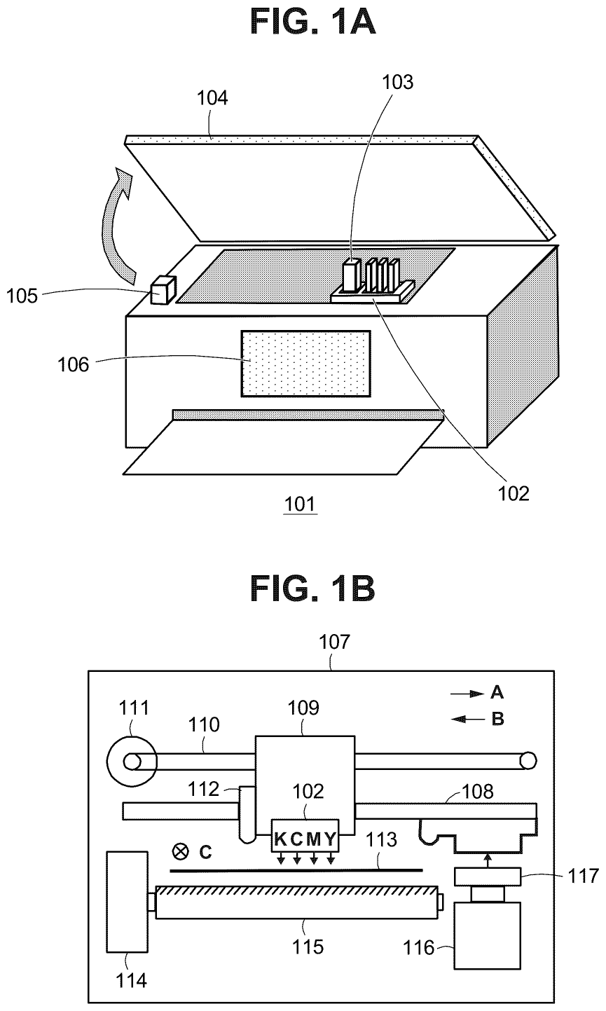

FIG. 1A is an external view illustrating an example of the configuration of an image processing apparatus according to an exemplary embodiment of the present disclosure.

As illustrated in FIG. 1A, an image processing apparatus 101 is a printer including one or more recording heads 102. In the following description, the image processing apparatus 101 includes one recording head 102. An ink tank 103 is attached to the recording head 102, and ink for recording in the ink tank 103 is supplied to the recording head 102. The ink tank 103 is detachably attached to enable a user to replace the ink tank 103 with a new one, as appropriate, with a cover 104 opened. In the image processing apparatus 101, a cover sensor 105 detects opening and closing of the cover 104.

A display unit 106 displays text, illustrations, or instruction pages on the Internet to notify the user of states, functions and usage of the image processing apparatus 101.

The image processing apparatus 101 according to the present exemplary embodiment employs an on-carriage method with the ink tank 103 mounted on the recording head 102. An off-carriage method can be employed where the ink tank 103 not mounted on a carriage, and ink is supplied to the recording head 102 using a recording head tube. The image processing apparatus 101 according to the present exemplary embodiment employs an inkjet method, but any other printing method, such as electrophotographic method, can be used.

FIG. 1B illustrates an example of the configuration of a printing unit 107 of the image processing apparatus 101.

The printing unit 107 is provided with a carriage 109 that moves in a reciprocating manner on a guide shaft 108 in directions indicated by arrows A and B. The recording head 102 including nozzle rows of four colors, black (B), cyan (C), magenta (M), and yellow (Y) is mounted on the carriage 109.

The carriage 109 is connected to a carriage motor 111 via a belt 110. A printing/recording operation corresponding to one scanning operation is performed by transmitting a drive pulse to the recording head 102 as the carriage 109 is moved by the power transmitted from the carriage motor 111 via the belt 110. A sensor 112 is provided at a position adjacent to the recording head 102 on the carriage 109. A result printed/recorded by the recording head 102 can be read using the sensor 112 while the carriage 109 is moved.

A recording medium 113 is fed by a predetermined distance every printing/recording operation corresponding to one scanning operation of the carriage 109 in a direction indicated by an arrow C via a conveyance roller 115 driven by a conveyance motor 114. This operation is repeated to complete the printing/recording operation corresponding to one page of the recording medium 113.

A recovery mechanism 116 including a cap mechanism 117 for capping the recording head 102 to prevent the recording head 102 from being dried is provided opposite the recording head 102 at a position that is off the recording medium 113 in the direction indicated by the arrow A. The image processing 101 apparatus moves the carriage 109 to a position where the recording head 102 is opposed to the cap mechanism 117, and then the recovery mechanism 116 is driven. This configuration brings the cap mechanism 117 into contact with the recording head 102 to cap the nozzle portions of the recording head 102, which prevents the recording head from drying or ink from solidifying. This operation is hereinafter referred to as “capping”. This capping operation is automatically performed based on the operation control of the image processing apparatus 101 to maintain an appropriate printing quality.

When an ink image is fading or illegible even with the above-descried capping operation, the user can select and execute a maintenance operation from an operation panel. Examples of the maintenance operation includes an operation where the recording head 102 in contact with the cap mechanism 117 is subjected to head cleaning via a suction operation performed by the recovery mechanism 116. Another example of the maintenance operation is an operation where printing of an adjustment pattern or printing for checking states of the nozzles of the recording head 102 is performed. The above-described maintenance operations are merely examples, and other maintenance operation can be performed.

In the present exemplary embodiment, the recovery mechanism 116 includes the cap mechanism 117. In other exemplary embodiments, the cap mechanism 117 is separated from the recovery mechanism 116.

An example of the configuration of a control unit 202 of the image processing apparatus 101 will now be described.

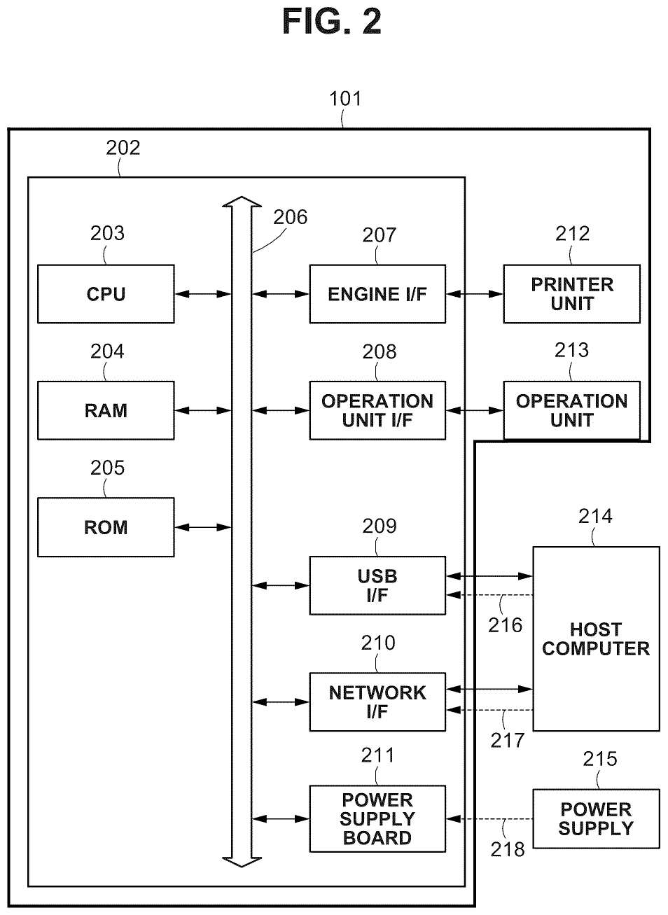

FIG. 2 is a block diagram illustrating an example of a hardware configuration of the image processing apparatus 101.

In the image processing apparatus 101, a central processing unit (CPU) 203 included in the control unit 202 loads control programs stored in a read-only memory (ROM) 205 into a random access memory (RAM) 204 and reads the control programs, as appropriate, to perform a power-on control operation and various control operations of the image processing apparatus 101. These control programs include various programs for controlling hardware modules of the image processing apparatus 101.

The RAM 204 is a main storage memory for the CPU 203 and is used as a work area or a temporary storage area for loading various programs stored in the ROM 205.

The ROM 205 stores image data, various programs, various pieces of setting information, and consumables count information (information indicating the amount of consumables used). In the present exemplary embodiment, a flash storage is used as the ROM 205, but an auxiliary storage, such as a hard disk, can be used.

In the image processing apparatus 101, a single CPU 203 executes processing illustrated in a flowchart described below with a single memory (RAM 204), but another configuration can be used. For example, a plurality of CPUs, RAMs, and ROMs, and storages can be operated in cooperation to execute the processes illustrated in the below flowchart. Some of the processes can be executed using hardware circuits.

A control unit 202 and a printer unit 212 are connected via an engine interface (I/F) 207. Image data to be recorded is transferred from the control unit 202 via the engine I/F 207 and is recorded on the recording medium 113, such as a sheet, by the printer unit 212.

The control unit 202 and an operation unit 213 are connected via an operation unit I/F 208. The operation unit 213 includes a liquid crystal display unit that includes a touch panel and operation keys and that functions as a reception unit for receiving instructions from a user.

A universal serial bus (USB) I/F 209 controls communication with a host computer 214 connected to the image processing apparatus 101 via a USB cable 216. A network I/F 210 controls communication with the host computer 214 connected to the image processing apparatus 101 via a network 217.

A power supply board 211 transforms the voltage of power supplied from a power supply 215 via a power supply cable 218 and supplies the power to the image processing apparatus 101. The power supply board 211 can include a storage battery that stores power.

A software configuration of the image processing apparatus 101 will now be described.

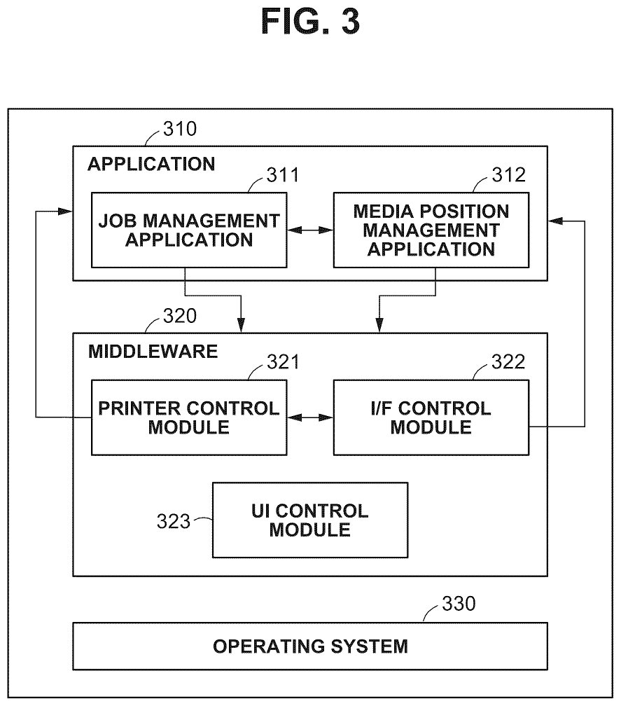

FIG. 3 is a block diagram illustrating an example of the software configuration of the image processing apparatus 101. The software configuration illustrated in FIG. 3 is operated by the CPU 203 of the image processing apparatus 101 loading control programs stored in the ROM 205 into the RAM 204 and executing the control programs.

A control program is divided into three blocks, an application layer 310 for managing applications, a middleware layer 320 for controlling devices via various I/Fs, and an operating system (OS) 330 for managing the control operation. The functions of these blocks will now be described.

The OS 330 provides basic functions for the control unit 202 to execute control programs.

The middleware layer 320 includes a software group for controlling I/Fs between the printer unit 212 and physical devices. In the present exemplary embodiment, the middleware layer 320 includes a printer control module 321 for controlling the engine I/F 207. The middleware layer 320 includes an I/F control module 322 for controlling the USB I/F 209 and the network I/F 210 as devices used to communicate with the host computer 214. The middleware layer 320 also includes a user interface (UI) control module 323 for controlling the operation unit I/F 208.

The application layer 310 includes software for causing devices to carry out, via middleware, functions of recording provided to a user, for example, from the image processing apparatus 101. If the UI control module 323 detects an instruction issued from a user to execute recording via the operation unit 213 and the operation unit I/F 208, a notification about the instruction is transmitted to the application layer 310. Upon receipt of the notification, the application layer 310 causes a job management application 311 for recording to operate. The job management application 311 controls the printer unit 212 via the engine I/F 207 with the printer control module 321 in the middleware layer 320, performing a recording operation or a cleaning operation.

A medium position management application 312 provides notifications about medium information obtained from the job management application 311 to the printer control module 321 in the middleware layer 320. The printer control module 321 controls the printer unit 212 based on medium information and obtains positional information about the recording medium 113. When no recording medium 113 is provided, the UI control module 323 is controlled to prompt a user to, for example, set a recording medium 113 in place.

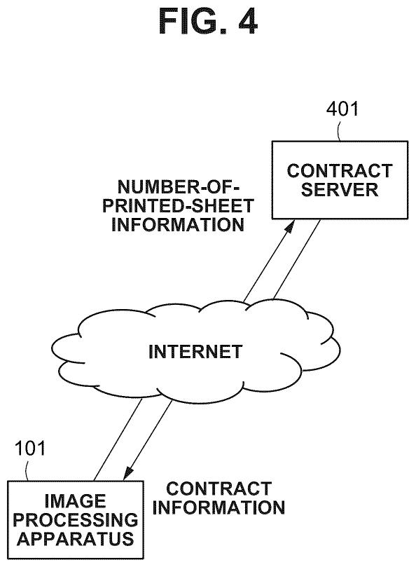

FIG. 4 is a diagram illustrating an example of a relationship between a contract server and the image processing apparatus 101 according to the present exemplary embodiment.

In the present exemplary embodiment, the subscription contract for the image processing apparatus 101 is managed by a contract server 401 connected via the Internet. The application layer 310 of the image processing apparatus 101 periodically receives information about the contract for the image processing apparatus 101 from the contract server 401, and the received contract information is stored in the ROM 205.

The contract information received by the application layer 310 from the contract server 401 includes a contract start date and time, a contract end date and time, and a settlement date in each month. The application layer 310 can obtain the current date and time, as appropriate, from the contract server 401. The format of the current date and time is based on, for example, International Organization for Standardization (ISO) 8601 (yyyy-MM-ddThh:mm:ssZ). The configuration where the current date and time are obtained from the contract server 401 makes it possible to uniformly manage the time of all image processing apparatuses 101 connected to the contract server 401. The terms “contract start date and time”, “contract end date and time”, and “settlement date and time” are used herein. However, in the present exemplary embodiment, information about time does not need to be included. More specifically, information simply indicating a year, a month, and a date can be used.

The application layer 310 of the image processing apparatus 101 stores in the ROM 205 the number of sheets printed, the amount of ink used, the number of times a maintenance menu is operated, etc., as consumables count information that is considered use information about the image processing apparatus 101 in various types of operation modes, and periodically transmits the consumables count information to the contract server 401.

The term “operation mode” as used herein refers to information for switching operations of the image processing apparatus 101, including a UI display, depending on the use application of the image processing apparatus 101. The current operation mode is stored as a setting value for the image processing apparatus 101 in the ROM 205. In the present exemplary embodiment, at least two operation modes, a “work” mode and a “private” mode, can be switched as a setting for the image processing apparatus 101 by a user input via the operation unit 213. The image processing apparatus 101 counts pieces of information about the amount of consumables used (this information is hereinafter referred to as “consumables count information”) for each of the operation modes, and stores the count information in the ROM 205. The operation modes can also be switched via the network I/F 210.

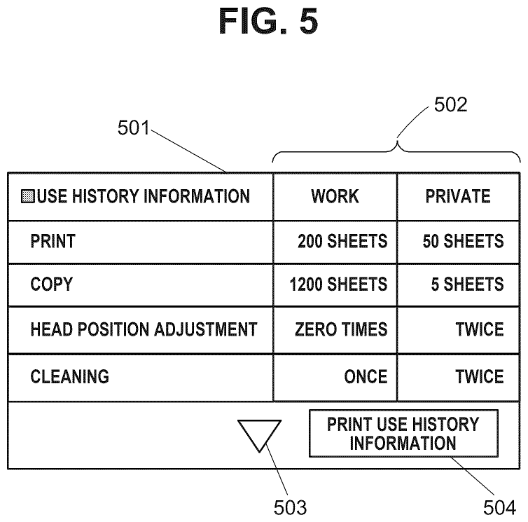

FIG. 5 illustrates an example of a screen (a use history screen) for displaying a use history of the image processing apparatus 101. This screen is displayed on an operation panel of the operation unit 213 under the control of the UI control module 323.

The use history screen includes display areas for an operation items list 501, a count display area 502 for the two operation modes, an operation items list scroll button 503, and a use history formation print button 504.

Examples of the operation items displayed in the operation items list 501 include operation items for printing, copying, head position adjustment, and cleaning. The information displayed in the count display area 502 about the two operation modes includes counts about consumables in the work mode and the private mode.

The operation items list 501 and the count display area 502 for the two operation modes are displayed based on the consumables count information stored in the ROM 205. If the list of items is not be fully displayed in the screen, a user can select the operation items list scroll button 503 to scroll the rest of items to be displayed. When a user selects the use history formation print button 504, detailed information greater than or equal to the contents displayed on the screen can be printed on a sheet.

In the present exemplary embodiment, an example is described where a user pays a fixed fee every month based on a subscription contract to be permitted to use functions of the image processing apparatus 101 up to a predetermined number of sheets to be printed. Thus, in the present exemplary embodiment, an example is described where when a normal printing operation, such as printing or copying, is performed, the number of sheets printed is counted, and if a maintenance operation, such as a head position adjustment or cleaning operation, is performed, the number of operations executed is counted as the above-described consumables count information or information displayed on the use history screen based on the consumables count information. The consumables count information is not particularly limited to this example as long as the consumables count information indicates amounts of consumables used, and information indicating the amount of printing agent used, such as ink, can be included.

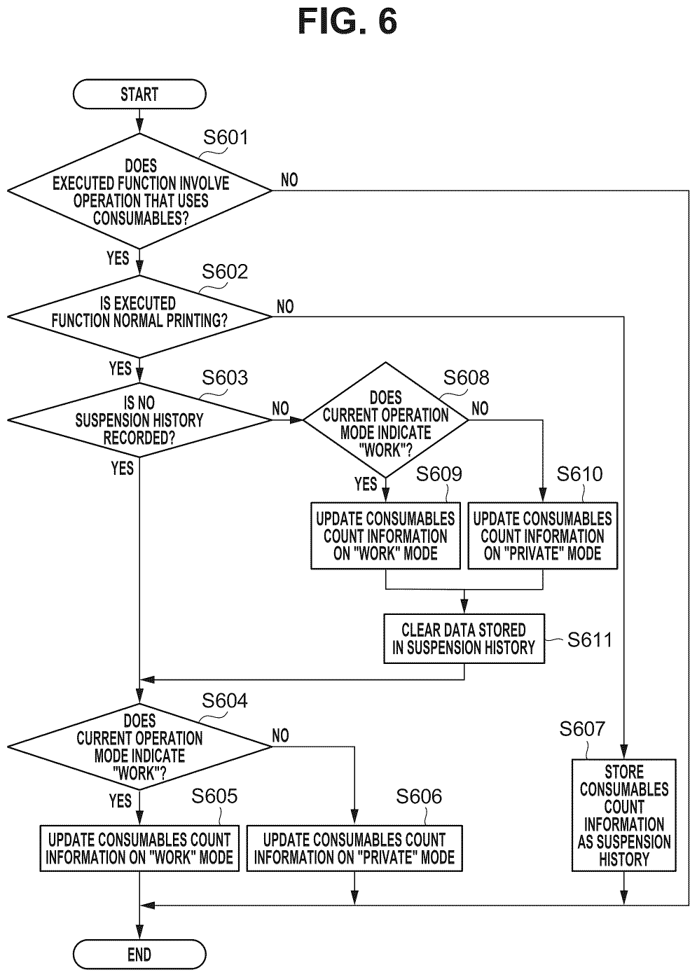

Processing where the image processing apparatus 101 determines to which of the operation modes the consumables count information belong in executing functions will now be described with reference to FIG. 6.

FIG. 6 is a flowchart illustrating an example of a processing for determining consumables count information recording destination according to the present exemplary embodiment. This processing is performed by CPU 203 of the image processing apparatus 101 loading programs stored in the ROM 205 into the RAM 204 and executing the programs.

The processing of this flowchart is performed every execution of a function of the image processing apparatus 101.

First, in step S601, the CPU 203 determines whether the executed function is an operation that uses consumables. If the CPU 203 determines that the executed function is not an operation that uses consumables (NO in step S601), the CPU 203 terminates the processing of this flowchart.

If the CPU 203 determines that the executed function is an operation that uses consumables (YES in step S601), the processing proceeds to step S602.

In step S602, the CPU 203 determines whether the executed function is a normal printing. The term “normal printing” as used herein refers to printing of desired contents from a user, such as a copy, text, or image, except for the maintenance operations of the image processing apparatus 101.

If the CPU 203 determines that the executed function is a normal printing (YES in step S602), the processing proceeds to step S603.

In step S603, the CPU 203 determines whether no suspension history is stored in the ROM 205. A suspension history is stored in step S607 as described below.

If the CPU 203 determines that no suspension history is stored (YES in step S603), the processing proceeds to step S604.

In step S604, the CPU 203 determines which of the operation modes is currently set in the image processing apparatus 101. If the CPU 203 determines that the current operation mode is for “work” (YES in step S604), the processing proceeds to step S605.

In step S605, the CPU 203 updates the consumables count information about the “work” mode about the operation items (e.g., “print” or “copy”) corresponding to the executed normal printing in the ROM 205 based on the consumables count information used in the executed normal printing. The processing of this flowchart then ends.

If the CPU 203 determines that the current operation mode is for “private use” (NO in step S604), the processing proceeds to step S606.

In step S606, the CPU 203 updates the consumables count information about the “private” mode about the operation items corresponding to the executed normal printing in the ROM 205 based on the consumables count information used in the executed normal printing. The processing of this flowchart then ends.

Returning to step S602, if the CPU 203 determines that the executed function is not a normal printing (NO in step S602), the processing proceeds to step S607.

In step S607, the CPU 203 stores in the ROM 205 information about the operation items corresponding to an operation other than the executed normal printing (e.g., “head position adjustment” or “cleaning”) and the consumables count information used in the operation as the suspension history. The processing of this flowchart then ends. The operation mode set in the execution of the operation can be stored in association with the suspension history.

Returning to step S603, the CPU 203 determines that a suspension history is stored (NO in step S602), the processing proceeds to step S608.

In step S608, the CPU 203 determines which of the operation modes is currently set in the image processing apparatus 101.

If the CPU 203 determines that the “work” mode is set as the current operation mode (YES in step S608), the processing proceeds to step S609.

In step S609, the CPU 203 updates the consumables count information about the “work” mode corresponding to the operation item information in the suspension history in the ROM 205 based on the consumables count information stored in the suspension history, and then the processing proceeds to step S611.

If the CPU 203 determines that the “private” mode is set as the current operation mode (NO in step S608), the processing proceeds to step S610.

In step S610, the CPU 203 updates the consumables count information about the “private” mode corresponding to the operation item information in the suspension history in the ROM 205 based on the consumables count information stored in the suspension history, and then the processing proceeds to step S611.

In step S611, the CPU 203 clears the data stored in the suspension history in the ROM 205, and then the processing proceeds to step S604. The processing of step S604 and subsequent steps are described above, and thus the descriptions thereof are omitted herein.

In a normal printing operation, the image processing apparatus 101 performs a control to count the amount of consumables used (consumables count information) in the normal printing operation as the amount of consumables used corresponding to an operation mode in the execution of the normal printing operation. When an operation that uses consumables (e.g., a maintenance operation, such as “head position adjustment” or “cleaning”) other than the normal printing is performed, the image processing apparatus 101 performs a control to count the amount of consumables used (consumables count information) in the operation as the amount of consumables used corresponding to an operation mode set in the execution of the next normal printing.

As described above, the image processing apparatus 101 can be used in a plurality of operation modes switched for different use applications, such as for work and private use, and has a function of determining an invoice recipient who is responsible for the cost of consumables depending on the use application. This function, when a maintenance operation is performed by a user operation, stores consumable consumption information about the maintenance operation in the suspension history. Based on an operation mode set in the execution of the next normal printing, it is determined whether the maintenance operation is for printing for work or private use, so that the consumables consumption information can be counted in association with the appropriate invoice recipient who is responsible for the printing cost. In other words, the invoice recipient responsible for the cost of consumables used in the maintenance operation can be appropriately determined. This enables avoiding situations where a user pays for the cost of consumables used for work (business) while a company pays for the cost of consumables used for private use.

The consumables consumption information used in an operation related to maintenance other than the normal printing is stored in the suspension history together with the operation mode set in the execution of the operation. When the image processing apparatus 101 is turned off, or has been out of operation for more than a predetermined period, the consumables count information stored in the suspension history can be counted as the consumables count information for work or private use based on the operation mode set in the execution of an operation corresponding to the information. In the above-described examples, the consumables count information stored in the suspension history can be divided into the information for work and the information for private use, for example, based on a use proportion in a given month, and the information can be counted.

According to the above-described present exemplary embodiment, an image processing apparatus that switches operation modes depending on a use application can appropriately determine an invoice recipient who is responsible for the cost of a function used involving consumables consumption other than the normal printing, such as a maintenance performed by a user operation.

This configuration enables avoiding situations where a user is responsible for the cost of consumables used for business and a company or employer is responsible for the cost of consumables used for private use.

The above-described configurations and contents of various data are not limited to these various configurations and contents, and can be used depending on a use application or purpose.

While the exemplary embodiment has been described above, embodiments of the present disclosure can be practiced in forms, such as a system, an apparatus, a method, and a program or a storage medium. The present disclosure can be applied to a system including a plurality of devices, and can also be applied to an apparatus constituting a single device.

### Other Embodiments

The present disclosure can be implemented by processing in which a program for implementing one or more functions according to the exemplary embodiment described above is supplied to a system or an apparatus via a network or a storage medium, and one or more processors in a computer of the system or the apparatus read and execute the program. The present disclosure can also be implemented by a circuit (e.g., an application-specific integrated circuit (ASIC)) for implementing one or more functions according to the exemplary embodiments.

The present disclosure is not limited to the above-described exemplary embodiments. Various modifications can be made based on the scope of the present disclosure, and such modifications are not eliminated from the scope of the present disclosure. Any configuration obtained by combining the above-described exemplary embodiments and modified examples thereof is included in the present disclosure.

The disclosure of the exemplary embodiments includes the following configurations, method, and program.

### Configuration 1

An image processing apparatus that is usable in a plurality of operation modes switched for different use applications, and is configured to count consumable consumption information indicating information about an amount of a consumable used for each of the operation modes, the image processing apparatus comprising a control unit configured to perform a control, based on an execution of an operation that uses the consumable, to count the consumable consumption information indicating the amount of the consumable used in the execution of the operation in association with an operation mode set in the execution of the operation. In a case where the executed operation is an operation related to a maintenance operation, the consumable consumption information indicating the amount of the consumable used in the execution of the operation is counted in association with an operation mode set in an execution of a next printing operation unrelated to the maintenance operation.

### Configuration 2

The image processing apparatus according to Configuration 1, further comprising a storage unit configured to store the consumable consumption information indicating the amount of the consumable used in the execution of the operation related to the maintenance operation together with an operation mode set in the execution of the operation, wherein in cases where the image processing apparatus is turned off or the image processing apparatus has been out of operation for more than a predetermined period, the consumable consumption information stored in the storage unit is counted in association with the operation mode stored together with the consumable consumption information.

### Configuration 3

The image processing apparatus according to Configuration 1 or 2, wherein the maintenance operation includes at least one of an operation for adjusting a position of a recording head or an operation for cleaning the recording head.

### Configuration 4

The image processing apparatus according to any one of Configurations 1 to 3, wherein the plurality of operation modes includes at least two operation modes that are an operation mode for work and an operation mode for private use.

### Method 1

A method for an image processing apparatus that is usable in a plurality of operation modes switched for different use applications, and is configured to count consumable consumption information indicating information about an amount of a consumable used for each of operation modes, the method comprising performing a control, based on an execution of an operation that uses the consumable, to count the consumable consumption information indicating the amount of the consumable used in the execution of the operation in association with an operation mode set in the execution of the operation, wherein in a case where the executed operation is an operation related to a maintenance operation, the consumable consumption information indicating the amount of the consumable used in the execution of the operation is counted in association with the operation mode set in an execution of a next printing operation unrelated to the maintenance operation.

### Program 1

A program for causing a computer to function as a control unit described in any one of Configurations 1 to 4.

According to an aspect of the present disclosure, for the cost of consumables charged depending on use applications, an invoice recipient responsible for the cost of consumables used in maintenance can be appropriately determined.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™M (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-183563, filed Oct. 25, 2023, which is hereby incorporated by reference herein in its entirety.

What is claimed is:

1. An image processing apparatus that is usable in a plurality of operation modes switched for different use applications and is configured to count consumable consumption information indicating information about an amount of a consumable used for each of the operation modes, the image processing apparatus comprising:
at least one memory storing at least one program; and
at least one processor, that when executes the at least one program causes the image processing apparatus to:
count, based on an execution of an operation that uses the consumable, the consumable consumption information indicating the amount of the consumable used in the execution of the operation in association with an operation mode set in the execution of the operation,
wherein in a case where the executed operation is an operation related to a maintenance operation, the consumable consumption information indicating the amount of the consumable used in the execution of the operation is counted in association with the operation mode set in an execution of a next printing operation unrelated to the maintenance operation.

2. The image processing apparatus according to claim 1,
wherein the consumable consumption information indicating the amount of the consumable used in the execution of the operation related to the maintenance operation is stored together with an operation mode set in the execution of the operation, and
wherein in a case where the image processing apparatus is turned off or the image processing apparatus has been out of operation for more than a predetermined period, the stored consumable consumption information is counted in association with the operation mode stored together with the consumable consumption information.

3. The image processing apparatus according to claim 1, wherein the maintenance operation includes at least one of an operation for adjusting a position of a recording head or an operation for cleaning the recording head.

4. The image processing apparatus according to claim 1, wherein the plurality of operation modes includes at least two operation modes that are an operation mode for work and an operation mode for private use.

5. A method for an image processing apparatus that is usable in a plurality of operation modes switched for different use applications and is configured to count consumable consumption information indicating information about an amount of a consumable used for each of the operation modes, the method comprising:
counting, based on an execution of an operation that uses the consumable, the consumable consumption information indicating the amount of the consumable used in the execution of the operation in association with an operation mode set in the execution of the operation,
wherein in a case where the executed operation is an operation related to a maintenance operation, the consumable consumption information indicating the amount of the consumable used in the execution of the operation is counted in association with the operation mode set in an execution of a next printing operation unrelated to the maintenance operation.

6. A non-transitory storage medium storing a computer program for executing a method for an image processing apparatus that is usable in a plurality of operation modes switched for different use applications, and is configured to count consumable consumption information indicating information about an amount of a consumable used for each of the operation modes, the method comprising:
counting, based on an execution of an operation that uses the consumable, the consumable consumption information indicating the amount of the consumable used in the execution the operation in association with an operation mode set in the execution of the operation,
wherein in a case where the executed operation is an operation related to a maintenance operation, the consumable consumption information indicating the amount of the consumable used in the execution of the operation is counted in association with the operation mode set in an execution of a next printing operation unrelated to the maintenance operation.
